(19) United States
(12) Patent Application Publication
(10) Pub. No.: US 2010/0254027 A1
(43) Pub. Date: Oct. 7, 2010

(54) OPTICAL APPARATUS, IMAGING APPARATUS, AND MANUFACTURING METHOD OF OPTICAL APPARATUS

(75) Inventor: Kyouji GENDA, Saitama (JP)

Correspondence Address: FOLEY AND LARDNER LLP;SUITE 500, 3000 K STREET NW, WASHINGTON, DC, 20007, US

(73) Assignee: TAMRON CO., LTD.

(21) Appl. No.: 12/721,902

(22) Filed: Mar. 11, 2010

(30) Foreign Application Priority Data
Apr. 2, 2009 (JP) 2009-089756

(51) Int. Cl. G02B 7/02; B23K 26/00

(52) U.S. Cl. 359/738; 359/811; 219/121.63

(57) ABSTRACT

An optical apparatus includes a first member; and a second member adjacent to the first member in an optical axis direction. The first member is made of a material that transmits at least part of laser light, and includes a welding recess caving in toward the second member along the optical axis direction, the welding recess being formed on an aspect facing away from the second member along the optical axis direction. The second member is made of a material that is compatible with the material of the first member and that absorbs at least part of the laser light, and is fixed by laser welding to the first member at a position overlapping the welding recess along the optical axis direction.

### CROSS-REFERENCE TO RELATED APPLICATIONS

This application is based upon and claims the benefit of priority from the prior Japanese Patent Application No. 2009-089756, filed on Apr. 2, 2009, the entire contents of which are incorporated herein by reference.

### BACKGROUND OF THE INVENTION

1. Field of the Invention

The embodiments discussed herein are related to an optical apparatus, an imaging apparatus having the optical apparatus, and a manufacturing method of the optical apparatus.

2. Description of the Related Art

In recent years, an increasing demand for reductions in the size of various types apparatuses having an imaging function (hereinafter “imaging apparatus”), such as cellular phones and compact cameras, has lead to a trend of size-reductions in optical elements, such as lenses, incorporated in such imaging apparatuses or optical apparatuses (optical systems) composed of multiple optical elements. Further, with respect to small-sized imaging apparatuses, such as cellular phones and compact cameras, there has been a trend toward imaging devices having greater pixel density and accompanying increases in the pixel density of imaging devices are demands for optical apparatuses that are not only compact, but also highly precise.

When a cast-in assembly method is adopted, although high-precision assembling can be achieved by reducing tolerances for optical elements making up an optical apparatus, reductions in the tolerances of optical elements decrease the mass production of the optical elements, thus leading to a decrease in yield in the mass production of the optical apparatus or imaging apparatus equipped with the optical apparatus. When a cast-in assembling method is adopted, the precision (optical performance) of the optical apparatus depends on the manufacturing precision of the components. For this reason, a broadening of the component tolerances to improve productivity results in a drop in the precision (optical performance) of the optical apparatus.

In manufacturing a resin product by injection molding using a resin material, relatively high manufacturing precision can be maintained by increased accuracy in molding technique and improvement in precise molding technique. Therefore, a technique to achieve precision (optical performance) for optical devices when a cast-in assembly method is applied has been used conventionally in which a positioning structure is provided in a resin optical element to position another optical element, and positioning of the other optical element is performed using this positioning structure.

Moreover, a technique to achieve demanded precision (optical performance) of an optical device by reference alignment has been used conventionally in which optical elements related to optical performance are aligned based on a reference optical element at assembly of the optical device, for example. Reference alignment is effective when optical elements are made from glass, such as lenses formed using a glass material by glass molding.

For glass optical elements that are formed of a glass material by glass molding or the like, reference alignment is required at the assembly of an optical system because it is difficult to achieve high eccentricity precision with a single glass optical element. For example, when a resin lens and a glass lens are both used in an optical device such as a lens unit for which the size is decreased by directly connecting lenses, by performing reference alignment of the glass lens relative to the resin lens of which manufacturing precision is high, the relative positions of the resin lens and the glass lens are adjusted.

In addition, for glass optical elements, because it is difficult to achieve manufacturing precision for a single optical element, it is difficult to provide a positioning structure with high precision to glass optical elements. For example, among glass optical elements, for a glass lens formed by glass molding, it is difficult to maintain high eccentricity precision of front and back lens surfaces, spacing with respect to an adjacent lens, high eccentricity precision of an optical surface with respect to contour, etc. As a result, conventionally, reference alignment work and spacing adjustment work are required in the assembly of an optical apparatus having a glass lens.

When a resin lens and a glass lens are present together, for example, each lens is positioned in the following manner. Since high manufacturing precision can be achieved for the resin lens, the resin lens can be positioned along the optical axis oriented perpendicular to the optical axis by fitting the resin lens at a given position in a resin lens holder. The positioned resin lens holder and the resin lens may be fixed using an UV-curing adhesive.

The glass lens is positioned along the optical axis by, for example, providing an interval adjusting spacer between an auxiliary ring holding the glass lens and the resin lens holder or the resin lens. The most suitable interval adjusting spacer is selected from among various types of spacers that are manufactured to have different patterns of thickness taking into consideration inconsistencies in the manufacturing precision of the glass lens.

The glass lens is oriented perpendicular to the optical axis by reference alignment relative to the resin lens. Because of the difficulty in achieving high manufacturing precision for the glass lens, neither the glass lens nor the auxiliary ring is provided with a positioning guide structure, etc. After the reference alignment, the relative positions of the resin lens and the glass lens are temporarily maintained by using, for example, an aligning jig, and then the resin lens and the glass lens are fixed at the positions by using a UV-curing adhesive (see, e.g., Japanese Patent Application Laid-Open Publication No. S63-269323).

Conventionally, the resin lens and the glass lens are fixed by using a UV-curing adhesive to improve workability. As the relative positions of the resin lens and the glass lens are maintained fixed with the aligning jig, the UV-curing adhesive is applied by potting, etc. The aligning jig is removed after the applied UV-curing adhesive is exposed to UV-rays to develop primary curing. The lenses rid of the aligning jig are kept in a place where secondary curing is accelerated.

A conventional technique related to an optical pickup is known, in which an optical element inserted in a light path of the optical pickup is fixed to a base member fitted with another optical element via a holding member made of a material having a linear expansion coefficient different from that of the base member (see, e.g., Japanese Patent Application Laid-Open Publication No. H07-210892).

According to the above technique, however, because the interval adjusting spacer having a thickness corresponding to the shape of the glass lens is disposed between the lens holder and the auxiliary ring, the space between the lens holder and the auxiliary ring is not consistent. The lens holder and the auxiliary ring arranged across the inconsistent space are thus fixed by using the adhesive, which results in an inconsistent application of the adhesive among optical apparatuses. The UV-curing adhesive continues to shrink following primary curing until the entire curing process is completed. If the application of the adhesive is inconsistent, the shrinkage of the adhesive until the completion of the entire curing process becomes different for each optical apparatus, which leads to a problem of inconsistencies in optical performance among the optical apparatuses.

Because the UV-curing adhesive continues to shrink following primary curing until the entire curing process is completed, according to the above conventional technique in which the aligning jig is removed after primary curing of the UV-curing adhesive, the adhesive which continues to shrink in secondary curing displaces the relative positions of the resin lens and the glass lens. This poses a problem in that a shift in the relative positions of the optical elements results in a drop in the optical performance of the optical apparatus.

In dealing with this problem, if the holding force of the jig is increased to keep the jig attached until the completion of secondary curing, stress caused by the shrinkage of the adhesive develops on the glass lens or the adhesive gluing the glass lens. This stress creates a distortion on the glass lens or the adhesive gluing the glass lens, which results in a displacement of the relative positions of the optical elements and a drop in the optical performance of the optical apparatus.

In the optical apparatus, the lens holder, the auxiliary ring, etc., are made of a black resin material through which UV-ray transmission is difficult. Thus, irradiation of UV-rays onto the adhesive in between the lens holder and the auxiliary ring is difficult. As a result, it takes a long time to complete the entire curing process of the adhesive, which results in a longer period of shrinkage of the adhesive in the curing process. This poses a problem in that displacement of the relative positions of the optical elements becomes substantial.

When optical elements fixed to each other by an adhesive have differing linear expansion coefficients, as in the case of the resin lens and the glass lens, a difference in the degree of expansion/shrinkage due to ambient temperature change results among the optical elements. Because of this difference, a compressive or tensile stress acts on the adhesive to deform the adhesive in some cases. The deformation of the adhesive shifts the relative positions of the optical elements or distorts the optical elements, thus posing a problem of a drop in optical performance.

The deformation of the adhesive becomes substantial as ambient temperature changes occur repeatedly, and displacement the relative positions of the optical elements and the distortion of the optical elements occur more frequently as the deformation of the adhesive becomes more substantial. As a result, repeated ambient temperature changes leads to a greater drop in optical performance. Trouble related to the difference in linear expansion coefficient between elements fixed to each other occurs also in the technique described in Japanese Patent Application Laid-Open Publication No. H07-210892. The technique described in this patent document has an additional problem in that reference alignment work cannot be conducted.

In dealing with the above problem, if the aligning jig is removed after the completion of secondary curing, assembling work cannot be carried out for a long time until the aligning jig is removed. This brings about a problem of a drop in yield in the mass production of an optical system and the optical apparatus or imaging apparatus having the optical system. In this case, a place for keeping the lenses fitted with the aligning jig must be secured for a long time until the aligning jig is removed, contributing to an increase in manufacturing cost.

According to the above conventional technique, the space between the glass lens and another lens is adjusted with the interval adjusting spacer. As a result, spacing adjustment has to be carried out incrementally making infinite adjustment impossible. Fine adjustment, therefore, is difficult. To carry out fine adjustments, multiple types of interval adjusting spacers varying slightly in thickness must be prepared, in which case component management becomes complicated and unrealistic.

In recent years, the demand for reductions in the size of imaging apparatuses has become high, which increases the demand for small-sized lens apparatuses. If configuration for fixing lenses incorporated in the lens apparatus becomes complicated, the number of elements increases and consequently, the size of the lens apparatus increases. A mechanism that fixes lenses incorporated in the lens apparatus, therefore, must firmly fix each of the lenses and have a simple configuration.

### SUMMARY OF THE INVENTION

It is an object of the present invention to at least solve the above problems in the conventional technologies.

An optical apparatus according to one aspect of the present invention includes first member; and a second member adjacent to the first member in an optical axis direction. The first member is made of a material that transmits at least part of laser light, and includes a welding recess caving in toward the second member along the optical axis direction, the welding recess being formed on an aspect facing away from the second member along the optical axis direction. The second member is made of a material that is compatible with the material of the first member and that absorbs at least part of the laser light, and is fixed by laser welding to the first member at a position overlapping the welding recess along the optical axis direction.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a first explanatory diagram of a lens apparatus according to an embodiment of the present invention;

FIG. 2 is a second explanatory diagram of the lens apparatus;

FIG. 3 is a third explanatory diagram of the lens apparatus;

FIG. 4 is first explanatory diagram of a portion of an assembly procedure of the lens apparatus according to the embodiment;

FIG. 5 is second explanatory diagram of a portion of an assembly procedure of the lens apparatus according to the embodiment; and

FIG. 6 is third explanatory diagram of a portion of an assembly procedure of the lens apparatus according to the embodiment.

### DETAILED DESCRIPTION OF THE PREFERRED EMBODIMENTS

Referring to the accompanying drawings, exemplary embodiments according to the present invention are explained in detail below. In the embodiment, an example of application of an optical apparatus according to the present invention as a lens apparatus is described.

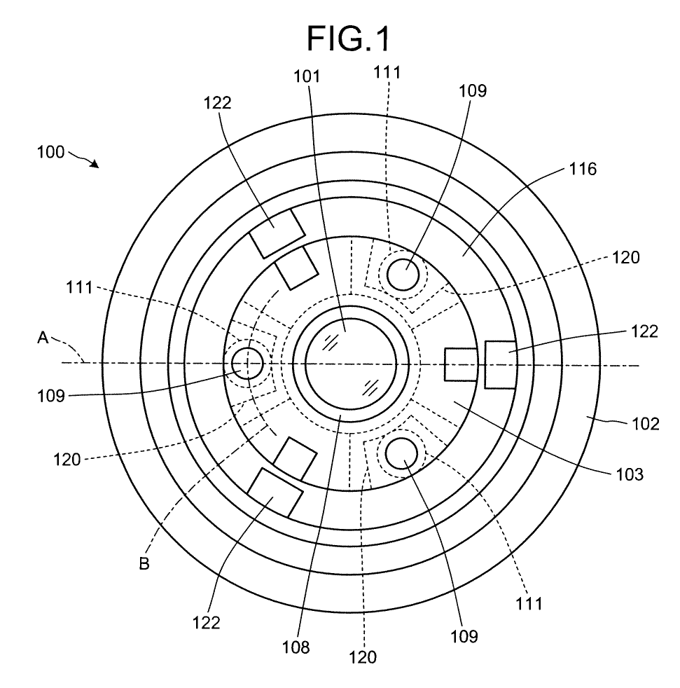

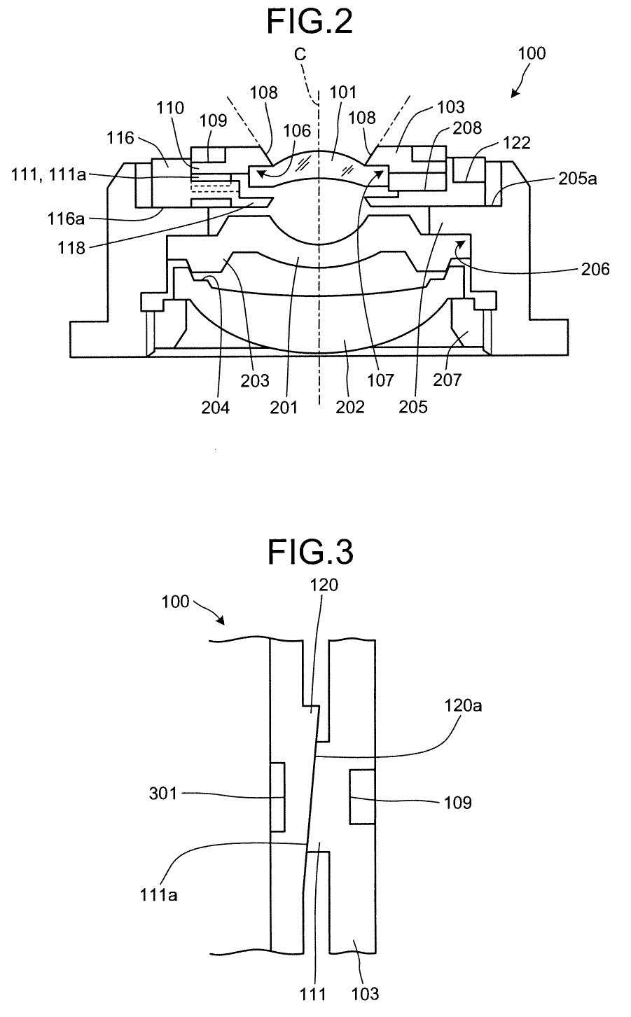

FIGS. 1, 2, and 3 are explanatory diagrams of a lens apparatus according to the embodiment of the present invention. FIG. 1 depicts a view of a group of lenses incorporated in the lens apparatus as viewed from an object-side of the lens apparatus, along the direction of an optical axis. FIG. 2 is a sectional view of the group of lenses incorporated in the lens apparatus, along line A depicted in FIG. 1. FIG. 3 is a close-up, sectional view of the group of lenses incorporated in the lens apparatus, along line B depicted in FIG. 1.

As depicted in FIGS. 1, 2, and 3, the lens apparatus according to the embodiment includes, sequentially from an object-side toward an ocular-side, a first lens 101, a second lens 201, and a third lens 202. Each of the first lens 101, the second lens 201, and the third lens 202 is disposed inside a substantially cylindrical lens barrel 102.

The lens barrel 102 is attached to a mount, etc., provided in a non-depicted imaging apparatus body, which has a photoelectric conversion element for imaging, i.e., an imaging device (non-depicted) disposed therein. The imaging device photoelectrically converts external light coming in via the lens apparatus 100 and outputs an electric signal corresponding to the intensity of the incident light.

The imaging device, for example, is a solid-state imaging device, such as a charge coupled device (CCD) image sensor and complementary metal oxide semiconductor (CMOS) image sensor.

In the lens apparatus 100, the optical axes of the first lens 101, the second lens 201, and the third lens 202 are aligned, i.e., the first lens 101, the second lens 201, and the third lens 202 are fixed in an aligned state relative to each other. The first, the second, and the third lenses 101, 201, and 202 are arranged overlapping each other along the optical axis direction (along the direction of overlap).

The first lens 101 is a glass lens formed by glass molding using a glass material. The first lens 101 may be formed using a glass material or may be formed using a material other than a glass material, such as resin material. The first lens 101 is held by retaining collar 103. In this embodiment, the first lens 101 serves as a primary lens.

The retaining collar 103 is of a substantially annular shape having a center at an optical axis C. The retaining collar 103 has an indented portion 106 on an interior aspect. The indented portion 106 is formed by varying the inner diameter of the retaining collar 103 in a direction toward the optical axis. The indented portion 106 has, for example, a first inner diameter portion substantially equal in dimension to the outer diameter of the first lens 101 and a second inner diameter portion smaller in dimension than the outer diameter of the first lens 101. The dimension of the second inner diameter portion is smaller than the dimension of the outer diameter of the first lens 101, and is of a dimension that opens an effective light path for the first lens 101.

In the retaining collar 103, the first lens 101 is inserted in a lens holding recess 107 formed by the first inner diameter portion. The first lens 101 and the retaining collar 103 are positioned relative to each other by aligning the first inner diameter portion with the outer diameter of the first lens 101. The first lens 101 and the retaining collar 103 are fixed in a state in which an object-side surface abuts a planar surface (indented portion 106) formed at the boundary between the first inner diameter portion and the second inner diameter portion of the retaining collar 103.

The retaining collar 103 and the first lens 101 are fixed, for example, by an adhesive. The retaining collar 103 and the first lens 101 may be fixed by press fitting the first lens 101 into a hole formed by the first inner diameter portion, or may be fixed by insert molding.

The retaining collar 103 has a masking wall 108, which is sloped relative to the optical axis so that aperture diameter becomes larger toward the object-side than the aperture diameter at the second inner diameter portion of the retaining collar 103 from the first lens 101 to the object-side. The masking wall 108 is formed to slope along the effective light path of the first lens 101. Thus, the retaining collar 103 holds the first lens 101 and is capable of preventing incidence of unnecessary external light onto the first lens 101.

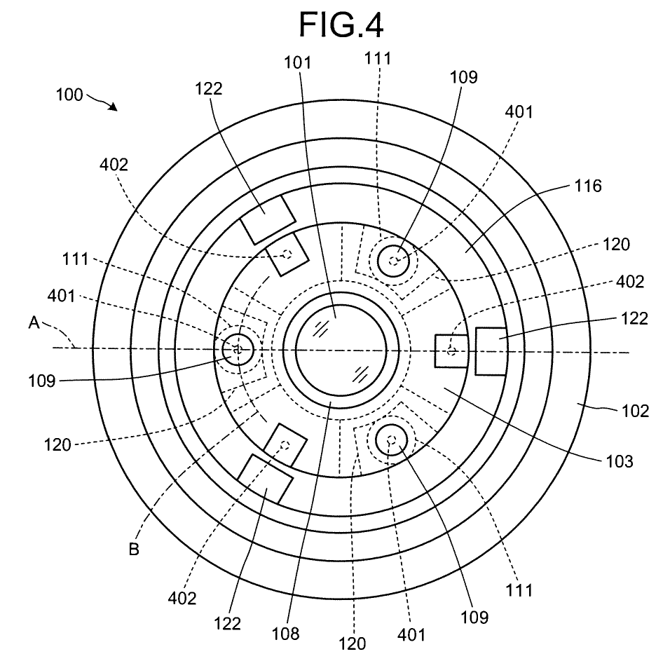

The retaining collar 103 has first recesses 109 caving in from the object-side surface toward the ocular-side. The first recesses 109 are formed by recessing, from the object-side surface of the retaining collar 103, sites that are exposed to laser light upon manufacturing the lens apparatus 100 (see reference numeral 401 of FIG. 4) and the peripheries of the sites.

The first recesses 109 are formed, for example, at three sites along a circle centered about the optical axis C. Formation of the first recesses 109 is not limited to three sites, and the first recesses 109 may be formed at positions arranged at equal intervals along a circle centered about the optical axis C. The number of the first recesses 109 may be determined to be any given number, such as two, three, and four or more.

As a result of formation of the first recesses 109, the dimension of the retaining collar 103 along the optical axis direction at the positions of formation of the first recesses 109, that is, the thickness (wall-thickness) of the retaining collar 103 at the positions of formation of the first recesses 109 is less than the thickness of the surrounding area of the positions. The thickness of the retaining collar 103 at the positions of formation of the first recesses 109 is adjusted to allow at least 10% of laser light to pass through to the ocular-side when laser light is irradiated from the object-side upon manufacturing the lens apparatus 100.

The retaining collar 103 has first projections 111 that project from an ocular-side surface of the body 110 of the retaining collar 103 toward the ocular-side. The first projections 111 are formed at the positions at which the first projections 111 overlap with the first recesses 109 along the optical axis direction. The first projections 111 are formed to be larger in area than the first recesses 109 on a plane perpendicular to the optical axis C, so that each first projection 111 is larger in diameter than each first recess 109.

An end, i.e., ocular-side end of the first projection 111 is formed into a first sloped surface 111a sloped relative to the optical axis. The first sloped surface 111a is sloped so that projection from the body 110 of the retaining collar 103 gradually becomes larger or smaller corresponding to the distance from the optical axis C. The first projection 111 is of a shape obtained by, for example, cutting a column diagonally against its longitudinal axis. The first sloped surface 111a is preferably a planar surface.

The retaining collar 103 is molded by injection molding using a resin material. Being molded by injection molding using the resin material, the retaining collar 103 is formed with high precision, thereby achieving precision in the position and slope angle of the first sloped surface 111a formed on the first projection 111.

The resin material making up the retaining collar 103 has a property of absorbing a portion of the irradiated laser light while transmitting other portions of the laser light. In this embodiment, the property of absorbing a portion of the irradiated laser light while transmitting other portions of the laser light will be described as “semi-transmission property” to laser light, hereinafter.

It is preferable that the resin material making up the retaining collar 103 be a resin material having a property of cutting off light of a given wavelength range, such as visible light. This allows only the effective light to be incident on the first lens 101 while assuredly preventing the incidence of harmful light other than effective light.

The resin material making up the retaining collar 103 is made by, for example, mixing or dispersing a material absorbing laser light into a base resin material having a property of transmitting laser light. In this embodiment, for example, a black polycarbonate (PC) resin material mixed with a black colored material transmitting infrared rays can be used as such resin material.

Laser (light amplification stimulated emission of radiation) light is coherent light produced by amplifying light (electromagnetic wave). For example, light of a wavelength in the near-infrared range can be used as laser light. For example, YAG laser is applicable. It is preferable to use laser light of 800 to 1100 nm produced using a YAG laser, YVO4 laser, semiconductor laser, etc.

“YAG” of the YAG laser represents the respective first letters of Yttrium, Aluminum, and Garnet. “YVO4” of the YVO4 laser is an abbreviation of Yttrium Vanadate, representing a type of a laser medium of a solid-state laser oscillator. Laser light is not limited to light of a wavelength in the near-infrared range, and may be light shorter in wavelength than visible light, such as UV-rays and X-rays, or light longer in wavelength than visible light, such as infrared rays.

The second lens 201 has a projection 203 projecting toward the third lens 202. The projection 203 is of an annular shape centered about the optical axis C. The shape of the projection 203 is not limited to an annular shape centered about the optical axis C, and may be divided into multiple portions along a circle centered about the optical axis C. The projection 203 has a taper shape having a width the decreases toward the third lens 202. The outer peripheral surface of the projection 203 is sloped relative to the optical axis.

The third lens 202 has a recess 204 into which the projection 203 is fitted. The recess 204 is a recess caving in from the object-side (closer to the second lens 201) surface of the third lens 202 toward the ocular-side. The inner peripheral surface of the recess 204 is sloped relative to the optical axis at substantially the same angle at which the outer peripheral surface of the projection 203 is sloped. The second lens 201 and the third lens 202 are positioned relative to each other by fitting the projection 203 formed on the second lens 201 into the recess 204 formed on the third lens 202.

Both the second lens 201 and the third lens 202 are molded by injection molding using a resin material. Being molded by injection molding using the resin material, the second lens 201 and the third lens 202 are formed with high precision. As a result, the precision of the relative positions of the second lens 201 and the third lens 202 can be ensured by merely fitting the projection 203 formed on the second lens 201 into the recess 204 formed on the third lens 202.

The second lens 201 and the third lens 202 are supported by the lens barrel 102, which is, for example, molded by injection molding using a resin material. Being molded by injection molding using the resin material, the lens barrel 102 is formed with high precision. The resin material making up the lens barrel 102 has a property of absorbing laser light (infrared laser light).

The resin material having the property of absorbing laser light is made by, for example, mixing or dispersing a material having a property of absorbing laser light into a base resin material. The resin material making up the lens barrel 102 is preferably black. This enables cutting off unnecessary external light (visible light) entering the lens barrel 102.

On the inner periphery of the lens barrel 102, a rib 205 is formed projecting from the inner peripheral surface of the lens barrel 102 toward the optical axis C. The rib 205 is of a ring shape centered about the optical axis C. A circle formed by the surface of the rib 205 closer to the optical axis C has a diameter smaller than the outer diameter of the second lens 201. This rib 205 forms an indented portion 206 on an interior aspect of the lens barrel 102. The indented portion 206 is made up of, for example, a portion having an inner diameter substantially identical in dimension to the outer diameter of the second lens 201 and a portion formed by the rib 205 having an inner diameter smaller in dimension than the outer diameter of the second lens 201.

The second lens 201 and the third lens 202, which are connected together by fitting the projection 203 into the recess 204, are inserted with their object-side end along the optical direction first, into the lens barrel 102. The portion of the lens barrel 102 formed of the rib 205 has an inner diameter smaller in dimension than the outer diameter of the second lens 201. This prevents the second lens 201 from passing through a space encircled by the rib 205 further into the lens barrel 102.

The object-side surface of the rib 205 is of a planar surface perpendicular to the optical axis C. This planar surface serves as a positioning surface 205a that positions a holding ring 116 in the optical axis direction. The holding ring 116 holds the retaining collar 103 holding the first lens 101, and is connected to the lens barrel 102 via the rib 205. The outer diameter of the holding ring 116 is smaller than the inner diameter of the lens barrel 102. This allows adjustment of the position of the holding ring 116 inside the lens barrel 102 on a plane perpendicular to the optical axis C. The holding ring 116 will be described later.

In the lens barrel 102, a retaining collar 207 is disposed on the ocular-side of the third lens 202. The retaining collar 207 is of a ring shape, and has a non-depicted screw thread on the outer peripheral surface. The screw thread formed on the outer peripheral surface of the retaining collar 207 is engaged with a non-depicted screw thread formed on the inner peripheral surface of the lens barrel 102 to fix the position of the retaining collar 207 relative to the lens barrel 102. The retaining collar 207 regulates the movement of the second and third lenses 201 and 202 toward the ocular-side so that the position of the second and third lenses 201 and 202 is fixed to the position at which the second lens 201 is in contact with the rib 205.

The above holding ring 116 is disposed between the retaining collar 103 and the lens barrel 102 in the optical axis direction. The ocular-side surface of the holding ring 116 is a planar surface perpendicular to the optical axis C. This planar surface serves as a positioning surface 116a that positions the holding ring 116 relative to the lens barrel 102 in the optical axis direction. In the lens apparatus 100, the holding ring 116 is positioned relative to the lens barrel 102 in the optical axis direction by bringing the positioning surface 116a of the holding ring 116 into contact with the positioning surface 205a of the rib 205 of the lens barrel 102.

The holding ring 116 is of an annular shape that opens the light path of the lens apparatus 100, and has a diaphragm aperture unit 118 forming a diaphragm aperture that adjusts the quantity of external light passing through the lens apparatus 100 to fall onto the imaging apparatus. The holding ring 116 is molded by injection molding using a resin material. Being molded by injection molding using the resin material, the holding ring 116 is formed with high precision.

The resin material making up the holding ring 116 has a semi-transmission property to laser light, and is compatible with the resin material making up the retaining collar 103 and with the resin material making up the lens barrel 102.

The same resin material making up the above retaining collar 103 can be used as the resin material making up the holding ring 116. The resin material making up the holding ring 116 is made by, for example, mixing or dispersing a material absorbing laser light into a base resin material having a property of transmitting laser light. As a result, laser light passes through part of the holding ring 116 while part of the holding ring 116 exposed to laser light absorbs laser light to weld the holding ring 116. In this embodiment, for example, a black PC resin material mixed with a black colored material transmitting infrared rays may be used as the resin material of the holding ring 116.

It is preferable that the resin material making up the holding ring 116 be a resin material having a property of cutting off light in a given wavelength range, such as visible light. This allows the diaphragm aperture formed by the diaphragm aperture unit 118 to assuredly cut off harmful light other than effective light coming through the first lens 101.

The holding ring 116 has a recess 208 whose inner diameter is equal to the outer diameter of the retaining collar 103. The recess 208 has an annular counter surface opposing the retaining collar 103. The holding ring 116 has second projections 120 projecting from the counter surface toward the retaining collar 103. The second projections 120 are formed at the positions such that the second projections 120 oppose the above first projections 111 along the optical axis direction. In other words, the second projections 120 are formed along a circle centered about the optical axis C, the circumference of which is equivalent to the circumference of the circle along which the first projections 111 are formed.

The same number of second projections 120 are formed as the first projections 111. For example, the second projections 120 are formed at three sites. Formation of the second projections 120 is not limited to three sites and may coincide in number to the first projections 111. The second projections 120 and the first projections 111 do not have to be the same in number, provided the second projections 120 and the first projections 111 are set opposing each other at equivalent positions on a circle centered about the optical axis C.

The end, i.e., object-side end, of the second projection 120 is formed into a second sloped surface 120a sloped relative to the optical axis. The second sloped surface 120a is sloped so that projection from the counter surface gradually becomes smaller or larger corresponding to the distance from the optical axis C. The second projection 120 is of a shape obtained by, for example, cutting a column diagonally against its longitudinal axis. The second sloped surface 120a is preferably a planar surface. The second sloped surface 120a is sloped at the same angle and in the same direction as the first sloped surface 111a of the first projection 111 so as to facially contact the first sloped surface 111a of the first projection 111.

The holding ring 116 has second recesses 301 caving in from the ocular-side surface toward the object-side. The second recesses 301 are formed at positions at which the second recesses 301 overlap the second projections 120 in the optical axis direction. A dimension of the second recesses 301 in a direction along a given circle centered about the optical axis C and a dimension of the second recesses 301 in a direction of the radius of the given circle are smaller than those of the second projection 120. In this embodiment, the second recesses 301 are provided as recesses for preventing erroneous welding.

The recess 208 shaped into a circle centered about the optical axis C has a diameter that is larger than the diameter of the holding ring 116. As a result, when the holding ring 116 is positioned in the recess 208, a space is formed between the inner peripheral surface of the recess 208 and the outer peripheral surface of the holding ring 116 in the direction of the radius of the circle centered about the optical axis C. The position of the holding ring 116 in the recess 208 can be adjusted by moving the holding ring 116 in this space.

On the object-side of the holding ring 116, cutouts 122 are formed by cutting out part of the outer peripheral edge of the holding ring 116. The cutouts 122 are formed by recessing the sites that are exposed to laser light upon manufacturing the lens apparatus 100 (see reference numeral 402 of FIG. 4) and the peripheries of the sites, from the object-side surface of the holding ring 116.

The cutouts 122 are formed along a circle centered about the optical axis C. The cutouts 122 are formed, for example, at three sites on the same circle centered about the optical axis C. Formation of the cutouts 122 is not limited to three sites, provided they are formed at equivalent positions on the circle centered about the optical axis C.

As a result of formation of the cutouts 122, the dimension of the holding ring 116 in the optical axis direction at the positions of formation of the cutouts 122, that is, the thickness (wall-thickness) of the holding ring 116 at the positions of formation of the cutouts 122 is less than the thickness of the surrounding area of the positions. The thickness of the holding ring 116 at the positions of formation of the cutouts 122 is adjusted to allow at least 10% of laser light to pass through to the ocular-side when laser light is irradiated from the object-side upon manufacturing the lens apparatus 100.

Lines connecting the second projections 120 to the optical axis C and lines connecting cutouts 122 to the optical axis C are radial lines of a circle centered about the optical axis C. In this embodiment, the second projections 120 and the cutouts 122 are formed to have a positional relation such that the lines connecting the second projections 120 to the optical axis C and the lines connecting cutouts 122 to the optical axis C appear alternately at equal intervals along a circle centered about the optical axis C. The radial lines of the circle centered about the optical axis C divide the central angle of the circle into 6 equal segments.

The positional relation between the second projections 120 and the cutouts 122 is not particularly limited, provided the second projections 120 and the cutouts 122 are each formed at equivalent positions along a circle centered about the optical axis C. The number of the second projections 120 may be different from the number of cutouts 122. For example, the number of the second projections 120, that is the first projections 111, and the number of the first recesses 109 may be three while the number of the cutouts 122 is two.

The holding ring 116 is fixed to the retaining collar 103 by laser welding. The holding ring 116 and the retaining collar 103 are welded and fixed together by laser at contact surfaces where the first projections 111 come in contact with the second projections 120. The holding ring 116 is fixed to the lens barrel 120 by laser welding. The holding ring 116 and the lens barrel 102 are welded and fixed together at contact surfaces where the positioning surface 205a of the rib 205 of the lens barrel 102 comes in contact with the ocular-side surfaces of the holding ring 116 at the position of overlap with the cutouts 122 in the optical axis direction. As a result, the retaining collar 103 and the lens barrel 102 are connected in a mutually fixed positional relation via the holding ring 116.

Laser welding is known as a technique of raising the temperature of a member made of a thermoplastic resin material by laser irradiation up to a temperature exceeding the melting point of the resin material and applying pressure to the member in a temperature-raised state to join together multiple members at a molecular level. In carrying out laser welding, basically, laser light is irradiated onto an interface at which a member made of a thermoplastic resin material having a property of absorbing laser light (hereinafter “laser-absorbing member”) and a thermoplastic resin material having a property of transmitting laser light (hereinafter “laser-transmitting member”) are brought into contact with each other. Laser light is irradiated from the side of the laser-transmitting member.

Techniques of joining members made of a thermoplastic resin material at a molecular level include impulse welding, hot-plate welding, noncontact hot-plate welding, ultrasonic welding, high-frequency welding, vibration welding, and infrared welding. Because the emission range of laser light can be reduced to be extremely small, even small members can be joined without fail by laser welding. In addition, laser welding enables members to be joined without the use of vibration, thus preventing a negative effect, such as the breakage of a member by vibrations generated upon welding.

A resin material used in laser welding is made by adding various coloring materials to a given base material. A thermoplastic resin material having a property of absorbing laser light may be provided as, for example, a resin material having a coloring material that is highly efficient in absorbing laser light of a wavelength range to be used and converting absorbed laser light into heat. A thermoplastic resin material having a property of transmitting laser light may be provided as, for example, a resin material having a dye-based coloring material that transmits most of laser light in a wavelength range to be used.

In laser welding, irradiated laser light is caused to reach a laser-absorbing member without melting the surface of a laser-transmitting member to raise the temperature of the laser-absorbing member to a temperature higher than the melting point of the laser-absorbing member. The heat of the laser-absorbing member is then conducted to the laser-transmitting member to melt it. Consequently, molecules of the laser-absorbing member and the laser-transmitting member join and mix together at a melted site. When laser light irradiation is stopped, the temperature of the melted resin material drops below the melting point, at which welding is completed.

Laser welding may be carried out in such a away that laser light is irradiated onto an interface at which a laser-absorbing member and a member made of a thermoplastic resin material having a semi-transmission property to laser light (hereinafter “laser semi-transmitting member”) are brought in contact with each other, from the side of the laser semi-transmitting member to join both members to each other at a molecular level. In this case, a mark of melting of the laser semi-transmitting member exposed to laser light becomes visible on the surface of the laser semi-transmitting member.

A heat sink may be used in laser welding using a laser semi-transmitting member. The heat sink, which is not depicted, is made by molding a material transmitting infrared rays into a given shape, such as plate-like shape. When the heat sink is stuck firmly to the laser semi-transmitting member and is exposed to laser light, laser light passes through the heat sink to reach the laser-absorbing member thereby heating the laser-absorbing member.

At this time, the heat sink dissipates heat from the laser light semi-transmitting member to the surroundings near the heat sink. This prevents heat generation at the surface of the laser light semi-transmitting member on the laser light irradiation side and the formation of a melt pool resulting from the heat generation. As a result, even when laser light is irradiated onto the laser light semi-transmitting member, a welded site formed by laser irradiation can be made untraceable.

By joining members to each other by laser welding, the members are joined to each other without using an adhesive. This suppresses a negative effect on the environment resulting from the use of adhesive. No need of the adhesive enables a reduction in the weight of the welded members, compared to a case of using adhesive.

In the lens apparatus 100 according to the embodiment, a first member is implemented by the retaining collar 103 and a second member by the holding ring 116. In this case, welding recesses are implemented by the first recesses 109. Further, in the lens apparatus 100, when the first member is implemented by the retaining collar 103 and the second member by the holding ring 116, a third member is implemented by the lens barrel 102.

In the lens apparatus 100, when the first member is implemented by the retaining collar 103 and the second member by the holding ring 116, a first holding member is implemented by the retaining collar 103 and the holding ring 116, and a second holding member by the lens barrel 102.

In the lens apparatus 100, the first member may also be implemented by the holding ring 116 and the second member may also be implemented by the lens barrel 102. In this case, the welding recesses may be implemented by the cutouts 122.

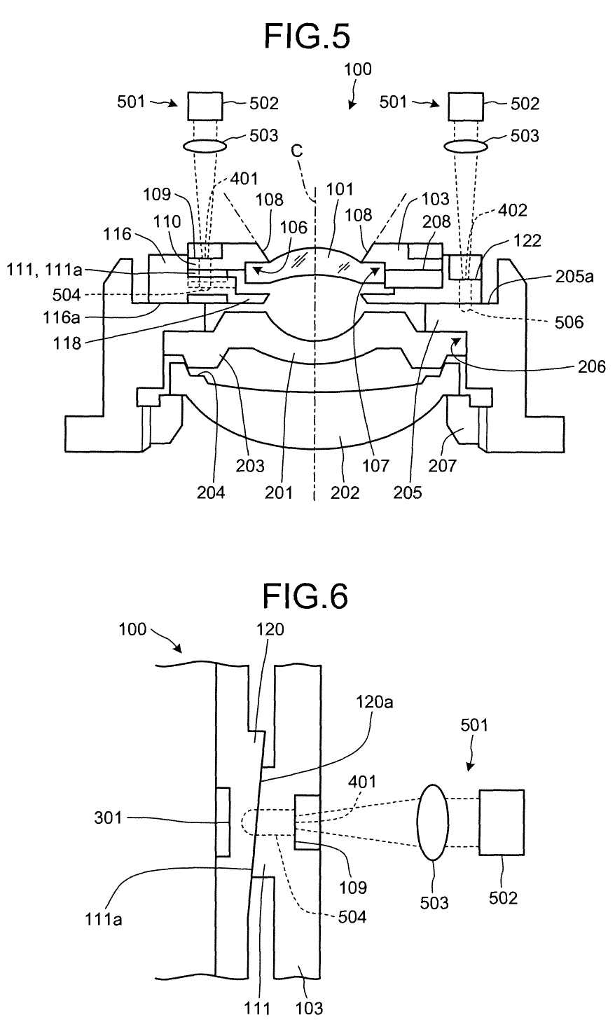

FIGS. 4, 5, and 6 are explanatory diagrams of part of an assembling procedure of the lens apparatus 100 according to the embodiment of the present invention. FIGS. 4, 5, and 6 are explanatory diagrams depicting a method of fixing the retaining collar 103 and the holding ring 116 to each other and a method of fixing the lens barrel 102 and the holding ring 116 to each other in the assembling procedure of the lens apparatus 100.

In FIGS. 4, 5, and 6, in fixing the retaining collar 103 and the holding ring 116 to each other and the lens barrel 102 and the holding ring 116 to each other, the second lens 201 and the third lens 202 in a mutually connected state are first inserted from the ocular-side of the lens barrel 102 into the lens barrel 102. The second lens 201 and the third lens 202 are pushed toward the object-side until the second lens 201 comes in contact with the rib 205.

When the second lens 201 comes in contact with the rib 205, the retaining collar 207 is inserted from the ocular-side of the lens barrel 102 into the lens barrel 102, and is screwed to the inner peripheral surface of the lens barrel 102. This fixes the position of the second lens 201 and the third lens 202 relative to the lens barrel 102. In fixing the retaining collar 103 and the holding ring 116 to each other, and the lens barrel 102 and the holding ring 116 to each other, the first lens 101 is separately fixed to the retaining collar 103.

Subsequently, the lens barrel 102 to which the second lens 201 and the third lens 202 are fixed is set on a non-depicted aligning jig, where the lens barrel 102 is set on the aligning jig with its object-side turned upward. The holding ring 116 is fitted in a recess of the lens barrel 102 set on the aligning jig.

The positioning surface 205a of the rib 205 and the positioning surface 116a of the holding ring 116 are brought into contact with each other. This precisely determines the position of the holding ring 116 with respect to the lens barrel 102. The retaining collar 103 to which the first lens 101 is fixed is fitted in the recess 208 of the holding ring 116 fitted in the recess of lens barrel 102. At this time, the first sloped surfaces 111a of the first projections 111 come in contact with the second sloped surfaces 120a of the second projections 120.

Subsequently, the position of the holding ring 116 with respect to the lens barrel 102 is fixed, and the retaining collar 103 to which the first lens 101 is fixed is turned about the axis C in a state where the first sloped surfaces 111a of the first projections 111 are in contact with the second sloped surfaces 120a of the second projections 120. This changes the state of contact between the first sloped surfaces 111a of the first projections 111 and the second sloped surfaces 120a of the second projections 120, and thus changes the position of the retaining collar 103 to the holding ring 116 along the optical axis direction.

The position of the retaining collar 103 changes in the direction of coming closer to or going away from the holding ring 116 along the optical axis direction according to the direction of turn about the optical axis C. When the position of the retaining collar 103 changes in the direction of coming closer to the holding ring 116 along the optical axis direction, the distance between the retaining collar 103 and the holding ring 116 along the optical axis direction decreases. When the position of the retaining collar 103 changes in the direction of going away from the holding ring 116 along the optical axis direction, the distance between the retaining collar 103 and the holding ring 116 along the optical axis direction increases.

In this manner, the distance between the first lens 101 fixed to the retaining collar 103 and the holding ring 116 can be adjusted by adjusting the distance between the retaining collar 103 and the holding ring 116 along the optical axis direction. In the lens apparatus 100 according to the embodiment, the retaining collar 103 to which the first lens 101 is fixed is turned about the optical axis C to adjust and optimize the space between the first lens 101 and the second lens 201.

Subsequently, the retaining collar 103 and the holding ring 116 are fixed to each other as the space between the first lens 101 and the second lens 201 is kept optimized. In fixing the retaining collar 103 and the holding ring 116 to each other, laser light is irradiated from the object-side onto laser light exposure positions 401 on the contact portions between the first sloped surfaces 111a of the first projections 111 and the second sloped surfaces 120a of the second projections 120. Laser light is, for example, irradiated parallel to the optical axis direction. On the contact portion between the first sloped surface 111a of the first projection 111 and the second sloped surface 120a of the second projection 120, the laser light exposure position 401 exposed to laser light is equivalent to a welding position.

Laser irradiation is carried out using a prescribed laser-emitting device 501. The laser-emitting device 501 includes a laser light source 502 and a lens 503 that condenses laser light emitted from the laser light source 502. The laser-emitting device 501 can be implemented easily by various known techniques, and is, therefore, omitted in further description.

In laser irradiation, the laser light exposure positions (exposure ranges) 401 are adjusted so that laser light is irradiated simultaneously in one round of irradiation onto three laser light exposure positions 401 on the contact portions between the first sloped surfaces 111a of the first projections 111 and the second sloped surfaces 120a of the second projections 120 that are formed on the same circle centered about the optical axis C.

In laser irradiation, for example, the laser light exposure positions (exposure ranges) may be adjusted by moving the laser light exposure positions (exposure ranges) so that laser light is irradiated sequentially onto three contact portions between the first sloped surfaces 111a of the first projections 111 and the second sloped surfaces 120a of the second projections 120 that are formed on the same circle centered about the optical axis C.

Laser light is irradiated onto the laser light exposure positions 401 on the contact portions between the first sloped surfaces 111a of the first projections 111 and the second sloped surfaces 120a of the second projections 120, and a portion of the laser light is absorbed by the retaining collar 103 while other portions of the laser light pass through the retaining collar 103 to be absorbed by the holding ring 116. Laser light absorbed by the retaining collar 103 and the holding ring 116 is converted into heat energy in the retaining collar 103 and the holding ring 116. Because the depth of the first recesses 109 is adjusted to absorb about 10% of irradiated laser light at the retaining collar 103, most of irradiated laser light reaches the holding ring 116.

Heat energy generated as a result of conversion of light energy in the retaining collar 103 and the holding ring 116 raises the temperature of sites exposed to laser light on the retaining collar 103 and the holding ring 116. On the retaining collar 103 and the holding ring 116, only the resin material at sites whose temperature has increased to exceed the melting point melts. As a result, melt pools are formed at the laser light exposure positions 401, i.e., the welding positions.

Because the second sloped surfaces 120a of the second projections 120 are in contact with the first sloped surfaces 111a of the first projections 111, heat energy generated in the second projections 120 of the holding ring 116 is conducted to the first projections 111 to raise temperatures thereof. On each first projection 111, only the resin material at a site whose temperature has increased to exceed the melting point melts. As a result, a melt pool is formed at the welding position.

In this embodiment, because the second sloped surface 120a of the second projection 120 is in contact with the first sloped surface 111a of the first projection 111 and a portion of the irradiated laser light is absorbed by the retaining collar 103, irradiated light energy is converted into heat energy also in the retaining collar 103, which raises the temperature of the first projection 111. On the first projection 111, only the resin material at a site whose temperature has increased to exceed the melting point melts. As a result, a melt pool is formed at the welding position.

At the welding position, the resin material forming a melt pool on the first projection 111 of the retaining collar 103 and the resin material forming a melt pool on the second projection 120 of the holding ring 116 mixes with each other because of mutual compatibility, and thus form a single melt pool 504. The single melt pool 504 includes the resin material making up the retaining collar 103 and the resin material making up the holding ring 116.

As described above, the retaining collar 103 and the holding ring 116 are made of resin materials compatible with each other. Because of this, the resin material making up the retaining collar 103 and the resin material making up the holding ring 116 uniformly mixes with each other in the single melt pool 504 formed by a melt pool on the first projection 111 of the retaining collar 103 and a melt pool on the second projection 120 of the holding ring 116.

When laser irradiation is stopped after the formation of the single melt pool 504 by the first projection 111 of the retaining collar 103 and the second projection 120 of the holding ring 116, the temperature of the resin material making up the single melt pool 504 drops to cause the melt pool 504 to cure. The cured single melt pool 504 makes up part of the retaining collar 103 as well as part of the holding ring 116. This means that the temperature of the resin material making up the single melt pool 504 drops to cause the melt pool 504 to cure to consequently join the retaining collar 103 to the holding ring 116 via the resin material making up the single melt pool 504.

The second recess 301 is formed at a position at which the second recess 301 overlaps the second projection 120 along the optical axis direction. Therefore, even if laser light reaches the ocular-side end of the holding ring 116 to melt the holding ring 116, the second recess 301 prevents the holding ring 116 melted by the energy of laser light from sticking to the lens barrel 102. This prevents fixing of the holding ring 116 to the lens barrel 102 at an undesired position.

Because laser light can be irradiated onto a precise site in a small exposure range, the welding pool can be formed precisely at the site to be joined on the contact portion between the first sloped surface 111a of the first projection 111 and the second sloped surface 120a of the second projection 120. This enables joining the retaining collar 103 to the holding ring 116 without damaging the appearance of the joined site.

The retaining collar 103 has the first recesses 109 caving in from the object-side surface toward the ocular-side, and laser light is irradiated onto the contact portions between the first sloped surfaces 111a of the first projections 111 and the second sloped surfaces 120a of the second projections 120 via the first recesses 109. This makes portions melted by laser irradiation barely visible from the outside of the lens apparatus 100, thus enables joining the retaining collar 103 to the holding ring 116 without damaging the appearance of the lens apparatus 100.

Using the heat sink in laser irradiation prevents heat generation at the object-side surface of the retaining collar 103 and the formation of a melt pool due to the heat generation. Thus, a welded site formed by laser irradiation is not visible from the object-side and thereby, improves the appearance of the lens apparatus 100.

The first lens 101 is aligned and fixed at an aligned position. In aligning the first lens 101, the holding ring 116, to which the retaining collar 103 is fixed, is moved along the positioning surface 116a as the position of the holding ring 116 relative to the lens barrel 102 along the optical axis direction is maintained by bringing the ocular-side surface of the holding ring 116 into contact with the positioning surface 205a of the lens barrel 102. The holding ring 116 to which the retaining collar 103 is fixed, which means the first lens 101, thus moves on a plane perpendicular to the optical axis C.

When a position, at which the optical axis C of the first lens 101 is optimized, is identified by moving the first lens 101 on the plane perpendicular to the optical axis C, the position of the holding ring 116 relative to the lens barrel 102 is fixed at the position at which the optical axis C of the first lens 101 is optimized. In fixing the lens barrel 102 and the holding ring 116 to each other, laser light is irradiated from the object-side onto only the laser light exposure positions 402 that are at the positions overlapping the cutouts 122 along the optical axis direction on the contact portion between the positioning surface 205a of the lens barrel 102 and the positioning surface 116a of the holding ring 116. Laser light is, for example, irradiated parallel to the optical axis direction. On the contact portion between the positioning surface 205a of the lens barrel 102 and the positioning surface 116a of the holding ring 116, the laser light exposure positions 402 exposed to laser light are equivalent to welding positions.

In laser irradiation, the laser light exposure positions (exposure ranges) are adjusted so that laser light is irradiated simultaneously in one round of irradiation onto three sites overlapping the cutouts 122 in the optical axis direction on the contact portion between the positioning surface 205a of the lens barrel 102 and the positioning surface 116a of the holding ring 116.

In laser irradiation, for example, the laser light exposure positions (exposure ranges) may be adjusted by moving the laser light exposure positions (exposure ranges) so that laser light is irradiated sequentially onto three sites overlapping the cutouts 122 in the optical axis direction on the contact portion between the positioning surface 205a of the lens barrel 102 and the positioning surface 116a of the holding ring 116.

Laser light is irradiated onto three laser light exposure positions 402 on the contact portion between the positioning surface 205a of the lens barrel 102 and the positioning surface 116a of the holding ring 116, and a portion of the laser light is absorbed by the holding ring 116 while other portions of the laser light pass through the holding ring 116 to be absorbed by the lens barrel 102. Laser light absorbed by the holding ring 116 and the lens barrel 102 is converted into heat energy in the holding ring 116 and the lens barrel 102. Because the depth of the holding ring 116 at the positions overlapping the cutouts 122 is adjusted to absorb about 10% of irradiated laser light, most of irradiated laser light reaches the lens barrel 102.

Heat energy generated as a result of conversion of light energy in the holding ring 116 and the lens barrel 102 raises the temperature of a site exposed to laser light on the holding ring 116 and the lens barrel 102. On the holding ring 116 and the lens barrel 102, only the resin material at a site whose temperature has increased to exceed the melting point melts. As a result, a melt pool is formed at the welding position.

Laser light irradiated onto the laser light exposure positions 402 formed on the contact portion between the positioning surface 205a of the lens barrel 102 and the positioning surface 116a of the holding ring 116 is converted into heat energy in the holding ring 116 and the lens barrel 102 and thus, raises the temperature of the holding ring 116 and the lens barrel 102. On the holding ring 116 and the lens barrel 102, only the resin material at a site whose temperature has increased to exceed the melting point melts. As a result, a melt pool is formed at the welding position.

In this embodiment, because the positioning surface 205a of the lens barrel 102 and the positioning surface 116a of the holding ring 116 is in contact with each other and a portion of the laser light irradiated on the cutouts 122 is absorbed by the holding ring 116, irradiated light energy is converted into heat energy also in the holding ring 116 to raise the temperature thereof. On the holding ring 116, only the resin material at a site whose temperature has increased to exceed the melting point melts. As a result, a melt pool is formed at the welding position.

At the welding position, the resin material forming a melt pool on the holding ring 116 and the resin material forming a melt pool on the lens barrel 102 mixes with each other because of mutual compatibility, and thus form a single melt pool 506. The single melt pool 506 includes the resin material making up the lens barrel 102 and the resin material making up the holding ring 116.

The holding ring 116 and the lens barrel 102 are made of the resin materials compatible with each other. Because of this, the resin material making up the lens barrel 102 and the resin material making up the holding ring 116 uniformly mixes with each other in the single melt pool 506 formed of a melt pool on the lens barrel 102 and a melt pool on the holding ring 116.

When laser irradiation is stopped after the formation of the single melt pool 506 by the lens barrel 102 and the holding ring 116, the temperature of the resin material making up the single melt pool 506 drops to cause the melt pool 506 to cure. The cured single melt pool 506 makes up part of the lens barrel 102 as well as part of the holding ring 116. This means that the temperature of the resin material making up the single melt pool 506 drops to cause the melt pool 506 to cure to consequently join the lens barrel 102 to the holding ring 116 via the resin material making up the single melt pool 506.

Because laser light can be irradiated onto a precise site in a small exposure range, the welding pool 506 can be formed precisely at the site to be joined on the contact portion between the lens barrel 102 and the holding ring 116. This enables joining the lens barrel 102 to the holding ring 116 without damaging the appearance of the joined site.

The holding ring 116 has the cutouts 122 caving in from the object-side surface toward the ocular-side, and laser light is irradiated onto the contact portion between the positioning surface 205a of the lens barrel 102 and the positioning surface 116a of the holding ring 116 via the cutouts 122. This makes portions melted by laser irradiation barely visible from the outside of the lens apparatus 100, thus enables joining the lens barrel 102 to the holding ring 116 without damaging the appearance of the lens apparatus 100.

In this manner, in assembling the lens apparatus 100 according to the embodiment of the present invention, the retaining collar 103 holding the first lens 101 and the holding ring 116 are fixed to each other, and the holding ring 116 to which the retaining collar 103 is fixed is fixed to the lens barrel 102 to which the second lens 201 and the third lens 202 are fixed. The lens apparatus 100 is assembled in this manner.

While the retaining collar 103 and the holding ring 116 are fixed to each other and then the holding ring 116 and the lens barrel 102 are fixed to each other in the above embodiment, the order of assembling the lens apparatus 100 is not limited hereto. For example, the holding ring 116 and the lens barrel 102 may be fixed to each other first and then the retaining collar 103 and the holding ring 116 are fixed to each other. Fixing of the retaining collar 103 and the holding ring 116 and of the holding ring 116 and the lens barrel 102 may be carried sequentially or may be carried out simultaneously.

While an example of applying the present invention to an optical apparatus implemented by the lens apparatus 100 is described in the above embodiment, an optical apparatus to which the present invention applies is not limited to the lens apparatus 100. The optical apparatus of the present invention is applicable to various apparatuses equipped with multiple members fixed by laser welding.

As described above, the lens apparatus 100 implementing the optical apparatus according to the embodiment of the present invention includes the retaining collar 103 as an example of the first member and the holding ring 116 as an example of the second member, the retaining collar 103 and the holding ring 116 being arranged adjacent to each other along the optical axis direction. The retaining collar 103 is made of a material that transmits at least a portion of irradiated laser light, and has the first recesses 109 serving as the welding recesses caving in toward the holding ring 116 along the optical axis direction, the first recesses 109 being formed at positions on a rear aspect facing away from the holding ring 116 along the optical axis direction. The holding ring 116 is made of a material that is compatible with the material making up the retaining collar 103 and that absorbs at least a portion of irradiated laser light, and is fixed by laser welding to the retaining collar 103 at the positions overlapping the first recesses 109 along the optical axis direction.

According to the lens apparatus 100, the retaining collar 103 and the holding ring 116 can be fixed to each other by laser welding. This enables fixing the relative positional relation between the retaining collar 103 and the holding ring 116 in a short time.

According to the lens apparatus 100 of the embodiment, fixing the retaining collar 103 and the holding ring 116 to each other by laser welding prevents displacement of the relative positions of the retaining collar 103 and the holding ring 116 at fixing, displacement that occurs, for example, accompanying volumetric shrinkage during the curing process of an adhesive when the retaining collar 103 and the holding ring 116 are fixed using adhesive.

According to the lens apparatus 100, the depth of the first recesses 109 is changed to adjust the amount of laser light passing through to the holding ring 116 and thus, adjust the state of melting of the retaining collar 103 and the holding ring 116 by irradiated laser light. This enables firmly fixing the retaining collar 103 and the holding ring 116 to each other.

The lens apparatus 100 of the embodiment prevents a drop in optical performance due to a method of fixing the retaining collar 103 and the holding ring 116 to each other.

The lens apparatus 100 implementing the optical apparatus according to the embodiment of the present invention includes the holding ring 116 as an example of the first member and the lens barrel 102 as an example of the second member, the holding ring 116 and the lens barrel 102 being arranged adjacent to each other along the optical axis direction. The holding ring 116 is made of a material that transmits at least a portion of irradiated laser light, and has the cutouts 122 serving as the welding recesses caving in toward the lens barrel 102 along the optical axis direction, the cutouts 122 being formed at positions on a rear aspect facing away from the lens barrel 102 along the optical axis direction. The lens barrel 102 is made of a material that is compatible with the material making up the holding ring 116 and that absorbs at least a portion of irradiated laser light, and is fixed by laser welding to the holding ring 116 at the positions overlapping the cutouts 122 along the optical axis direction.

According to the lens apparatus 100, the lens barrel 102 and the holding ring 116 can be fixed to each other by laser welding. This enables fixing the relative positional relation between the lens barrel 102 and the holding ring 116 in a short time.

According to the lens apparatus 100 of the embodiment, fixing the lens barrel 102 and the holding ring 116 to each other by laser welding prevents displacement of the relative positions of the lens barrel 102 and the holding ring 116 at fixing, displacement that occurs, for example, accompanying volumetric shrinkage during the curing process of an adhesive when the lens barrel 102 and the holding ring 116 are fixed using adhesive.

According to the lens apparatus 100, the depth of the cutouts 122 is changed to adjust the amount of laser light passing through to the lens barrel 102 and thus, adjust the state of melting of the lens barrel and the holding ring 116 by irradiated laser light. This enables firmly fixing the lens barrel 102 and the holding ring 116 to each other.

The lens apparatus 100 of the embodiment prevents a drop in optical performance due to a method of fixing the lens barrel 102 and the holding ring 116 to each other.

According to the lens apparatus 100, the retaining collar 103 has the first projections 111 which project from an aspect behind the first recesses 109 toward the holding ring 116 along the optical axis direction and have ends forming the first sloped surfaces 111a sloped along the optical axis direction and along a circle centered about the optical axis C. The holding ring 116 has the second projections 120 which are located opposing the first projections 111 to project toward the retaining collar 103 and have ends sloped to be in contact with the sloped surfaces 111a. The retaining collar 103 and the holding ring 116 are fixed to each other by laser welding via the contact places between the first sloped surfaces 111a and the second sloped surfaces 120a.

According to the lens apparatus 100, the retaining collar 103 and the holding ring 116 are turned relative to each other about the optical axis C to change the state of contact between the first sloped surfaces 111a and the second sloped surfaces 120a. This enables infinite adjustment of the distance between the retaining collar 103 and the holding ring 116 along the optical axis direction and thus, enables adjusting and fixing the retaining collar 103 and the holding ring 116 at an arbitrary position.

According to the lens apparatus 100, the lens apparatus 100 includes the lens barrel 102 as an example of the third member that is disposed opposite to the retaining collar 103 with the holding ring 116 therebetween along the optical axis direction and that abuts the holding ring 116. The holding ring 116 has the recesses for preventing erroneous welding that are formed opposing the lens barrel 102, caving in away from the lens barrel 102, on an aspect behind (along the optical axis direction) the welding positions for welding to the retaining collar 103.

The lens apparatus 100 prevents such unintended conduction of the heat to the lens barrel 102, the heat being generated upon laser welding the retaining collar 103 and the holding ring 116 to each other, thereby preventing the lens barrel 102 from becoming deformed and erroneous welding of the holding ring 113 to the lens barrel 102.

According to the lens apparatus 100, the retaining collar 103 holds the first lens 101 that is a glass lens, and has the masking wall 108 serving as the masking unit that is made of a material cutting off visible light and that limits an incident angle of light to the first lens 101.

According to the lens apparatus 100, the glass first lens 101 requiring spacing adjustment and alignment to ensure optical performance can be fixed at a desired position, and the incident angle of light to the first lens 101 can be limited without increasing the number of elements.

According to the lens apparatus 100, the holding ring 116 has the diaphragm aperture unit 118 serving as an example of the masking unit that is made of a material cutting off visible light and that limits the amount of incident visible light; whereby, the amount of visible light that falls onto the lens apparatus 100 to pass through the holding ring 116 can be limited without increasing the number of elements.

The imaging apparatus according to the embodiment of the present invention includes the above lens apparatus 100 and the imaging photoelectric conversion device that converts external light received via the optical apparatus into an electric signal.

According to the imaging apparatus of the embodiment, the retaining collar 103 and the holding ring 116 are fixed to each other by laser welding enabling the relative positions of the retaining collar 103 and the holding ring 116 to be fixed in a short time. This prevents displacement of the relative positions of the retaining collar 103 and the holding ring 116 in fixing, displacement that occurs, for example, accompanying volumetric shrinkage during the curing process of an adhesive when the retaining collar 103 and the holding ring 116 are fixed using adhesive and thus, achieves stable imaging performance.

According to the imaging apparatus of the embodiment, the depth of the first recesses 109 is changed to adjust the amount of laser light passing through the retaining collar 103 to the holding ring 116 and thus adjust the state of melting of the retaining collar 103 and the holding ring 106 by irradiated laser light. This enables firmly fixing the retaining collar 103 and the holding ring 116 to each other and thus, achieves stable imaging performance.

According to the imaging apparatus of the embodiment, the retaining collar 103 and the holding ring 116 are fixed to each other by laser welding enabling the relative positions of the retaining collar 103 and the holding ring 116 to be fixed in a short time. This prevents displacement of the relative positions of the retaining collar 103 and the holding ring 116 in fixing, displacement that occurs, for example, accompanying volumetric shrinkage during the curing process of an adhesive when the retaining collar 103 and the holding ring 116 are fixed using adhesive and thus, achieves stable imaging performance.

According to the imaging apparatus of the embodiment, the depth of the cutouts 122 is changed to adjust the amount of laser light passing through to the lens barrel 102 and thus adjust the state of melting of the lens barrel 102 and the holding ring 106 by irradiated laser light. This enables firmly fixing the lens barrel 102 and the holding ring 116 to each other and thus, achieves stable imaging performance.

According to the lens apparatus 100 of the embodiment, the lens apparatus 100 includes the first lens 101, the second lens 201, and the lens barrel 102 serving as a second holding member that has the retaining collar 103 serving as the first member and the holding ring 116 serving as the second member holding the first lens 101 and adjusting the position thereof along the optical axis direction, where the retaining collar 103 and the holding ring 116 are fixed to each other by laser welding, and the lens barrel 102 holds the second lens. The retaining collar 103 and the holding ring 116 and the lens barrel 102 can be moved relative to each other on a plane perpendicular to the optical axis, and are laser welded to each other.

According to the lens apparatus 100 of the embodiment, the relative positional relation between the retaining collar 103 and the holding ring 116 and the lens barrel 102 on the plane perpendicular to the optical axis can be adjusted. This enables alignment of the optical axes of the first, the second, and the third lenses 101, 201, and 202 to achieve excellent optical performance of the lens apparatus 100.

According to the lens apparatus 100 of the embodiment, the retaining collar 103 is made of the laser-transmitting resin that holds the first lens 101, is in contact with the holding ring 116, and has the first sloped surfaces 111a configured to be able to move relative to the holding ring 116, and the holding ring 116 is made of the laser-absorbing resin, is in contact with the retaining collar 103, and has the second sloped surfaces 120a configured to be able to move relative to the retaining collar 103. The first sloped surfaces 111a are laser welded to the second sloped surfaces 120a.

According to the lens apparatus 100 of the embodiment, the relative positional relation between the retaining collar 103 and the holding ring 116 and the lens barrel 102 in the optical axis direction can be adjusted infinitely. This enables excellent optical performance of the lens apparatus 100 to be ensured.

According to the lens apparatus 100 of the embodiment, the lens barrel 102 is made of the laser-absorbing resin in contact with the holding ring 116 and is capable of moving relative to the holding ring 116 on a plane perpendicular to the optical axis direction, and the holding ring 116 is in contact with the lens barrel 102 at the contact portion made of the laser-transmitting resin and is capable of moving relative to the lens barrel 102 on the plane perpendicular to the optical axis direction.

According to the lens apparatus 100 of the embodiment, the relative positional relation between the retaining collar 103 and the holding ring 116 and the lens barrel 102 on the plane perpendicular to the optical axis direction can be adjusted infinitely. This enables excellent optical performance of the lens apparatus 100 to be ensured.

A manufacturing method of the lens apparatus 100 of the embodiment includes fixing the retaining collar 103 to the holding ring 116 by laser welding, where the retaining collar 103 serves as the first member holding the first lens 101 and adjusting the position thereof along the optical axis direction and the holding ring 116 serves as the second member to which the retaining collar 103 is fixed. The manufacturing method further includes fixing the lens barrel 102 to the holding ring 116 to which the retaining collar 103 is fixed by laser welding, where the lens barrel 102 serves as the second holding member that holds the second lens 201 and is capable of moving relative to the retaining collar 103 and the holding ring 116, which are fixed to each other by laser welding on a plane perpendicular to the optical axis.

According to the manufacturing method of the lens apparatus 100 of the embodiment, the relative positional relation between the retaining collar 103 and the holding ring 116 and the lens barrel 102 in the optical axis direction can be adjusted in manufacturing the lens apparatus 100. This enables excellent optical performance of the lens apparatus 100 to be ensured.

According to the lens apparatus 100 of the embodiment, the lens apparatus 100 includes the first lens 101 and, the retaining collar 103 and the holding ring 116 that hold the first lens 101. The retaining collar 103 is made of the laser-transmitting resin, holds the first lens 101, is in contact with the holding ring 116, and has the first sloped surfaces 111a configured to be movable relative to the holding ring 116, and the holding ring 116 is made of the laser-absorbing resin, is in contact with the retaining collar 103, and has the second sloped surfaces 120a configured to be movable relative to the retaining collar 103. The first sloped surfaces 111a are laser welded to the second sloped surfaces 120a.

According to the lens apparatus 100 of the embodiment, the position of the first lens 101 along the optical axis direction can be adjusted infinitely. This enables excellent optical performance of the lens apparatus 100 to be ensured.

The optical apparatus, the imaging apparatus, and the manufacturing method of the optical apparatus offer an effect of preventing displacement of the relative positions of optical elements consequent to the fixing the optical elements, thereby preventing a drop in optical performance due to the method of fixing the optical elements.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

This application is based upon and claims the benefit of priority from the prior Japanese Patent Application No. 2009-089756, filed on Apr. 2, 2009, the entire contents of which are incorporated herein by reference.

What is claimed is:

1. An optical apparatus comprising:
a first member; and
a second member adjacent to the first member in an optical axis direction, wherein
the first member is made of a material that transmits at least part of laser light, and includes a welding recess caving in toward the second member along the optical axis direction, the welding recess being formed on an aspect facing away from the second member along the optical axis direction, and
the second member is made of a material that is compatible with the material of the first member and that absorbs at least part of the laser light, and is fixed by laser welding to the first member at a position overlapping the welding recess along the optical axis direction.

2. The optical apparatus according to claim 1, wherein
the first member includes a first projection projecting from an aspect behind the welding recess toward the second member along the optical axis direction, the first projection having an end forming a first sloped surface sloped in the optical axis direction, and about a circle centered about an optical axis,
the second member includes a second projection opposing the first projection and projecting toward the first projection, the second projection having an end forming a second sloped surface sloped to be in contact with the first sloped surface, and
the first member and the second member are fixed to each other by laser welding via a contact site between the first sloped surface and the second sloped surface.

3. The optical apparatus according to claim 1, comprising
a third member disposed contacting the second member and sandwiching the second member with the first member along the optical axis direction, wherein
the second member includes a recess for preventing erroneous welding, the recess caving in away from the third member and formed behind a position of welding to the first member along the optical axis direction, on as aspect facing the third member.

4. The optical apparatus according to claim 1, wherein
the first member holds a glass lens and, includes a masking unit made of a material cutting off visible light and limiting an incident angle of light to the lens.

5. The optical apparatus according to claim 1, wherein
the first member includes a masking unit made of a material cutting off visible light and limiting a quantity of incident visible light.

6. An imaging apparatus comprising:
the optical apparatus according to claim 1; and
a photoelectric conversion element that converts, into an electrical signal, external light coming in via the optical apparatus.

7. An optical apparatus comprising:
a first lens;
a second lens;
a first holding member including a first member and a second member that are fixed to each other by laser welding, holding the first lens and adjusting a position of the first lens along an optical axis direction; and
a second holding member holding the second lens, wherein
the first holding member and the second holding member are movable relative to each other on a plane perpendicular to an optical axis and are laser welded to each other.

8. The optical apparatus according to claim 7, wherein
the first member is made of a laser-transmitting resin that holds the first lens, is in contact with the second member, and has a first sloped surface configured to be movable relative to the second member,
the second member is made of a laser-absorbing resin, is in contact with the first member, and has a second sloped surface configured to be movable relative to the first member, and
the first sloped surface is laser welded to the second sloped surface.

9. The optical apparatus according to claim 8, wherein
the second holding member is made of a laser-absorbing resin in contact with the second member, and is movable relative to the second member on the plane perpendicular to the optical axis, and
the second member is in contact with the second holding member at a contact portion made of a laser-transmitting resin, and is movable relative to the second holding member on the plane perpendicular to the optical axis.

10. A manufacturing method of an optical apparatus comprising:
laser welding a first member to a second member, the first member and the second member being included in a first holding member to hold a first lens and adjust a position of the first lens along an optical axis direction; and
laser welding a second holding member to the first holding member, the second holding member holding a second lens and being movable relative to the first holding member on a plane perpendicular to an optical axis.

11. An optical apparatus comprising:
a lens; and
a holding member that holds the lens, wherein
the holding member includes a first member and a second member that adjust a position of a first lens along an optical axis direction,
the first member is made of a laser-transmitting resin that holds the first lens, is in contact with the second member, and has a first sloped surface configured to be movable relative to the second member,
the second member is made of a laser-absorbing resin, is in contact with the first member, and has a second sloped surface configured to be movable relative to the first member, and
the first sloped surface is laser welded to the second sloped surface.
